(19) United States
(12) Patent Application Publication
(10) Pub. No.: US 2010/0303053 A1
(43) Pub. Date: Dec. 2, 2010

(54) AGGREGATED SESSION MANAGEMENT METHOD AND SYSTEM

(75) Inventors: Balash Akbari, Vancouver (CA); Lawrence Chee, Richmond (CA)

Correspondence Address: SCHWABE, WILLIAMSON & WYATT, P.C., 1420 FIFTH, SUITE 3400, SEATTLE, WA, 98101-4010, US

(73) Assignee: MOBIDIA, INC., Richmond (CA)

(21) Appl. No.: 12/472,863

(22) Filed: May 27, 2009

(51) Int. Cl. H04J 3/00

(52) U.S. Cl. 370/345

(57) ABSTRACT

A system and method for managing a session is provided wherein a sending computer, after a period of time in which a number of enumerated packets have been sent to a receiving computer, sends a report request to the receiving computer, which then sends to the sending computer a report containing an acknowledgement of the last packet received from said the sending computer, a list of any enumerated packets not received within the time period, and a rate of receipt of packets from the sending computer. If the sender receives a predetermined number of reports identifying the same packet as the last packet received, the session is terminated.

### FIELD OF INVENTION

The present invention relates to the field of packet-based networks.

### BACKGROUND OF THE INVENTION

A number of packet protocols have been developed and optimized for wired networks. For example, the congestion control used in the Transmission Control Protocol (TCP) has been adapted over time to achieve maximum throughput in fixed bandwidth networks, and to work in a “fair” manner, even during heavy network congestion. However, as many packet based networks now include a wireless infrastructure, these congestion mechanisms in TCP are not well suited to the different characteristics found in such a wireless infrastructure. These different characteristics include:
1. A longer latency/round trip time. The lower bandwidth of a wireless network introduces a considerable amount of latency for a packet. The longer latency is also caused by the nature of a shared network, in which each session waits for the appropriate scheduling to enter the network.

2. Variable bandwidth. The bandwidth to a given mobile or wireless device is a function of many factors. For example as a user moves, the distance to the antennae moves, which may result in obstructions. Even if the user is stationary there are factors that can impact bandwidth, including vehicles moving between the user and the antennae, other users on the network entering and leaving the shared medium, proximity to other networks and the associated power/bandwidth management of the radio frequency (RF).

The longer latency and longer round trip time impair TCP's ability to quickly ascertain the available bandwidth in a static bandwidth environment. In an environment with a high variable bandwidth, the problem of TCP efficiently tracking the available bandwidth is amplified.

Variable bandwidth can also indirectly lead to packet drop, which is a concern for a wireless network operator. In a situation in which two or more TCP sessions are made aware of available bandwidth in the wireless network, they will increase their data flow speed. This can result in an overloading of the buffers inside the network. Consequently, packets can be dropped off of the tail of the buffer. When there is an excess of packets and some are dropped, retransmission occurs, consuming the resources that otherwise could be used to transport new packets.

There are often multiple, simultaneous TCP sessions from multiple sources all destined for a single endpoint. An example would be a user surfing the Internet (which contains multiple sessions in itself) on a mobile device, while downloading an email. With multiple sessions, all independent of each other, the difficulty in ascertaining the available bandwidth across all the sessions is increased. This traffic can be characterized as “bursty”, in that in the aggregate of all sessions, the instantaneous bandwidth can far exceed or be well below the overall capacity of the wireless network.

Several solutions have been brought forward to solve these efficiency issues. For example, compression techniques can be applied to all of the packet flows spanning the wireless network. This technique can dramatically improve the efficiency by simply reducing the actual number of bytes that need to be transferred. This solution is particularly effective for text based transfers; however, the bulk of packets traversing the networks are typically multi-media based content (e.g. video, jpeg images and photos) which in themselves are already highly compressed and thus the efficiency gains of additional compression may be negligible without impacting image quality.

U.S. Pat. No. 6,721,334 discloses aggregating multiple packets from different sources to one client at a proxy server, so that the number of connections that must be made is reduced. This results in increased likelihood of packet fragmentation due to the larger packet size. In addition, it requires complex rewriting of the packets at the proxy server which is processor intensive. Furthermore, the method forbids any implementation of Quality of Service as it makes preferential treatment of certain data flows impossible by the network devices that transport the data flows.

U.S. Pat. No. 7,035,214 discloses a means of reducing unnecessary traffic by using a negative acknowledgement (NACK). Only unreceived packets result in a NACK being sent. The receiver recognizes that a packet has been lost by comparing sequence numbers of received packet. For example, if receiver receives packets 1, 2, 3, and 5, it recognizes that packet 4 is missing and sends a NACK for packet 4 while at the same time starting a missing-packet-timer. When the sender receives the NACK it retransmits the missing packet 4. If the missing-packet-timer runs out before the successful retransmission of packet 4 then an additional NACK is sent and the timer restarted. If the network is interrupted, and a number of consecutive packets dropped, then there will be as many NACKs transmitted as there would be acknowledgements (ACKs) in traditional TCP.

U.S. Pat. No. 6,771,659 discloses a selective acknowledgement scheme for wireless networks on the interface between sender and receiver. It uses a proxy to handles all TCP handshaking, and transmitting the payload to a receiver. Before transmitting the payload, the proxy classifies the packets into one of two categories: “acknowledge” or “not acknowledge”. Packets classified as “acknowledge” incite an ACK from the receiver and packets classified as “not acknowledge” do not. The proxy does select a representative “not acknowledge” packet to incite an ACK. If the proxy receives the ACK for this “not acknowledge” packet, then it assumes that the other “not acknowledge” packets in its representative class were also received correctly. While this scheme does reduce the number of packets on the network, it makes an assumption that because the representative packet is received correctly then all packets in its class were. This can result in problems, particularly with variable bandwidth issues.

### SUMMARY OF THE INVENTION

It is highly desirable that any improvements in efficiency to TCP be “invisible” to users and applicable to existing servers that serve as the source of TCP sessions, as well as to clients that are the recipients of the TCP sessions. It is also important that any improvements have no effect on other network traffic, and that Quality of Service is maintained.

The system and method according to this invention are implemented within a proxy that may span the entire wireless network, with a server element in the core of the wireless network, and a client embedded in a wireless device (for example a laptop with 3G modem, or a 3G Smartphone). The proxy eliminates TCP in the wireless network; extracts the payloads found in each TCP session, converts the payloads into UDP, and transports the payloads across the wireless network in a reliable and holistic manner.

The system and method according to the invention provides mobile operators (i.e. the companies that own and operate the wireless networks) a way of lowering their capital expenditure (CAPEX) by extending the life of existing equipment. Such equipment is expensive to purchase and deploy.

New equipment, such as next generation wireless networks with greater bandwidth than the currently available equipment, will also benefit from the system and method according to the invention, which provides benefits in bandwidth variability/long-latency environments.

In addition, mobile operators benefit by decreasing their operational expenditure (OPEX). Current wireless networks use backhaul fibres and copper wires linking the different network components (for Universal Mobile Telecommunications Systems (UMTS), these include Gateway General Packet Radio Service (GRPS), Serving Support Node (GGSN), Serving GPRS Support Node (SGSN), Radio Network Controller (RNC), and Node B) that are physically distributed across a region that make up the wireless network. These interconnections may be over-provisioned to deal with the “bursty” traffic pattern exhibited by TCP and over-provision is necessary to minimize packet loss. The nature of traffic utilizing the system and the method according to the invention is smooth (as opposed to bursty), eliminating the need to over-provision the network links. As a result, operators can reduce the speed of the backhaul interconnections, which in turn reduces OPEX.

As well, as there is a small latency and variability between the far host(s) server and the proxy, and as the proxy performs the needed handshaking, the system and method according to the invention reduces the probability of incurring a session timeout.

Lastly, the operator's customers, who use the wireless network to access the internet, benefit by experiencing faster browsing and downloading.

A method of managing a session is provided, including receiving, at a receiver, a plurality of enumerated packets from a sender within a time period; receiving, at the receiver, a request from the sender for a report; and if said receiver has received one or more of the plurality of packets from the sender within the time period, preparing, at the receiver, a report comprising an acknowledgement of the last packet received from the sender, a list of any enumerated packets not received within the time period, and a rate of receipt of packets from the sender; and sending, from the receiver, the report to the sender.

On receipt of a the request, if the sender does not receive the report, the sender increases the time period, and after the increased time period, sends a second request for a report to the receiver. After the sender has sent a predetermined number of requests for reports to the receiver, and the sender has not received the report from the receiver, the sender terminates the session. The increased time period may be determined by adding a time to the time period or multiplying the time period by a multiplier.

A system for managing a session between a first computer and a second computer is provided, including: a server managing the session by receiving packets from the first computer, enumerating the packets and sending the packets to the second computer; and after an interval of a fixed time period, transmitting a request for a report from the second computer; wherein the second computer, after receiving the request, transmits a report to the server, the report containing an acknowledgement of the last packet received from the server, a list of any enumerated packets not received within the time period, and a rate of receipt of packets received from the server.

A method of managing a session between a sending computer and a receiving computer, after the sending computer has sent a plurality of enumerated packets to the receiving computer within a fixed time period, including: sending a report request to the receiving computer, the report request having a timestamp; receiving, from the receiving computer, a report, the report including the timestamp, a list of the enumerated packets not received from the sending computer within the time period, and an acknowledgement of a last packet amongst the plurality of packets received.

### DESCRIPTION OF THE FIGURES

FIG. 1 is a block diagram showing the architecture and data flow according to an embodiment of the invention;

FIG. 2 is a block diagram showing components of a cell module in an embodiment according to the invention;

FIG. 3 is a flow diagram showing the process taken in acknowledging receipt of packets in an embodiment according to the invention;

FIG. 4 is a time diagram thereof;

FIG. 5 is a diagram of an embodiment of a report-request packet according to the invention; and

FIG. 6 is a diagram of an embodiment of a report packet according to the invention.

### DESCRIPTION OF THE INVENTION

The aggregated session management (ASM) system and method according to the invention manages all the sessions destined for a single mobile device in a holistic manner, so that both the efficiency and the reliability of the network are increased. The system and method can be used to track all of the sessions intended for a mobile device, will send all appropriate ACKs to their respective senders, and manage the transmitted packets internally.

As such, the ASM system monitors all sessions and accounts for dropped packets by providing a report to the far host server. This report acts as an ACK on the aggregate of packets from all sessions sent during a certain time interval. More specifically, following the receipt of a report-request from a sender, the receiving mobile device will send a report, which is an ACK-type packet listing all the packets not received during the previous time interval. The sender, as it is aggregating all sessions, enumerates the packets and thus the receiver can deduce which packets were not received.

Upon receipt of the ACK report, the sender acts as if the report were a number of independent ACKs. The ACK report is preferably based on a time interval, not on a per session basis. Therefore, the frequency of ACK reports can be customized to suit the current needs of the wireless network, e.g. if a device is dormant; the frequency of report-requests is decreased.

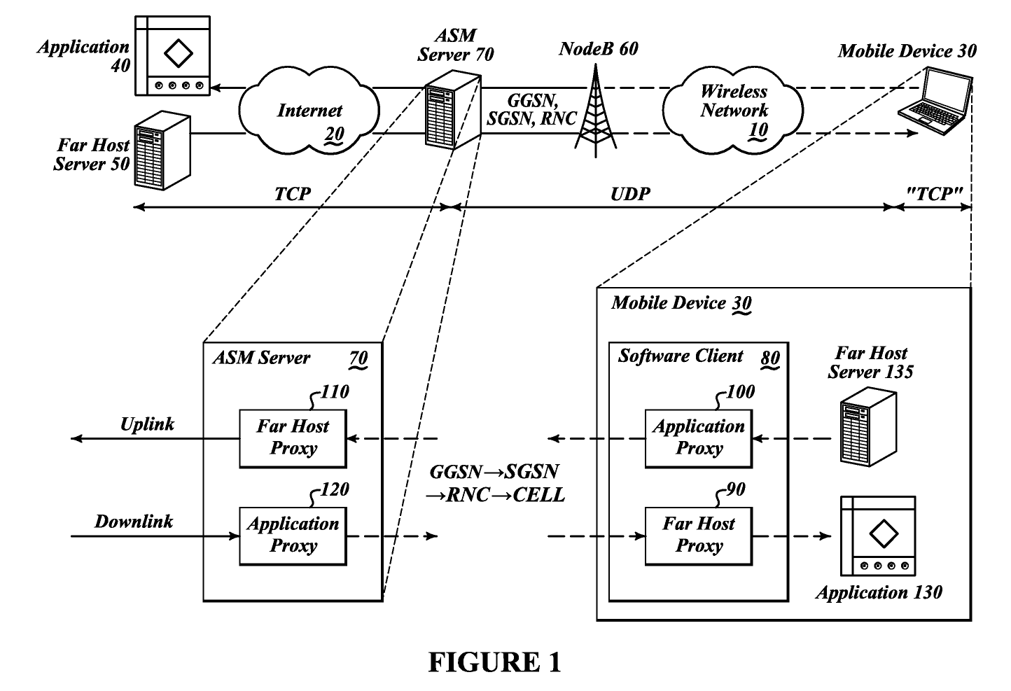

As seen in FIG. 1, the system according to the invention is implemented on a network, including wireless network 10 and a wired network, such as the Internet 20. The system manages data flow between mobile device 30 and application 40 operating on far host server 50. Mobile Device 30 accesses application 40, first through wireless network 10 which is linked to Node B 60, and then through GGSN, SGSN, or RNC to ASM Server 70, which in turn accesses application 40 through the Internet 20. UDP is the protocol used for packets transmitted between ASM server 70 and mobile device 30, while TCP is used for packets transmitted between ASM server 70 and far host server 50.

ASM server 70 is located at the point of initial traffic entry from the internet to the mobile network. In a UMTS or GSM based network, this is at the Gi interface of GGSN. Mobile device 30 includes software client 80, which includes far host proxy 90 and application proxy 100. ASM Server 70 includes far host proxy 110 and application proxy 120.

Application proxies 100, 120 terminate the TCP flows, extract the payload and encapsulate the payload into a UDP packet. The far host proxies 90, 110 receive the UDP packet, extract the payload and present the payload to the application as a TCP packet.

Application proxy 120 within ASM server 70 terminates TCP flows from far-host server 50 within the Internet 20. Within software client 80, application proxy 100 terminates TCP flows from the application 130 running on mobile device 30. Mobile device 30 acts as far host server 135 in messages sent to application 40.

Far host proxy 110 within ASM server 70 essentially reverses the effects of application proxy 120 by converting packets to TCP. Within software client 80 however, the TCP packet is not created but the payload is presented to application 130 as though it came from a TCP socket of the operating system operating on mobile device 30.

ASM server 70 uses application proxy 120 for downstream data flow (i.e. to mobile device 30) and uses far host proxy 110 for upstream data flow (i.e. to far host server 50). Software client 80 uses application proxy 100 for upstream data flow and far host proxy 90 for downstream data flow. Combined, the four proxies, 90, 100, 110 and 120 are referred to herein as the Dynamic Multimedia Proxy (DMP).

ASM server may be one or several computers, with conventional components, including input and output means, a processor, and a memory.

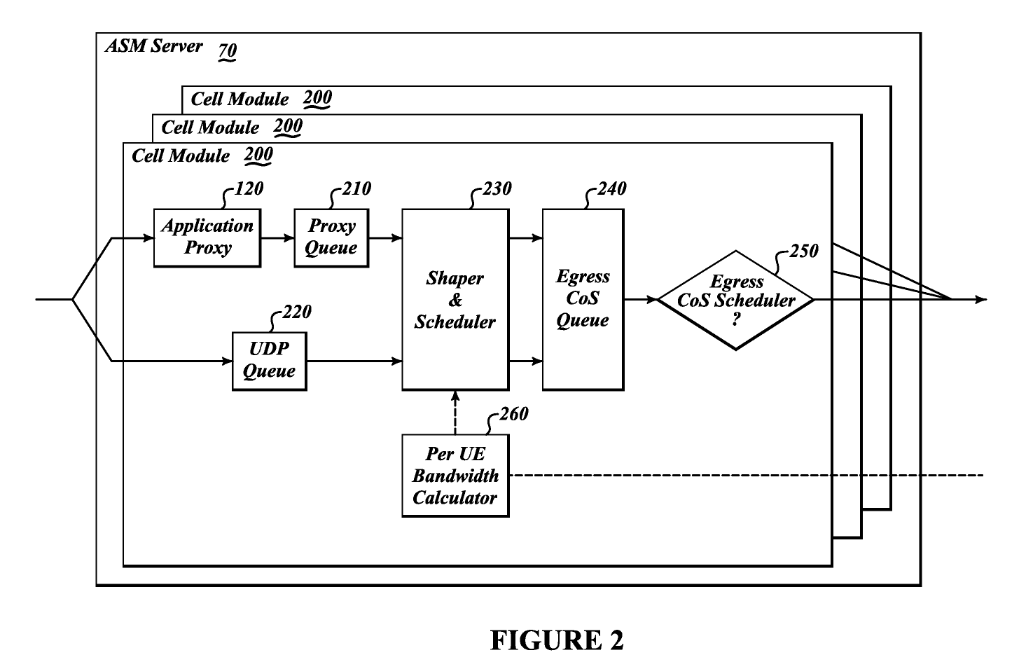

Application proxy 120 on ASM server 70 has several additional components to provide efficient packet flow. As, typically, there are multiple cells within wireless network 10, each cell manages its own data flow. Therefore, within ASM server 70, multiple cell modules 200 are present, as shown in FIG. 2. Each cell within wireless network 10 is assigned a unique cell module 200 for monitoring traffic.

Each cell module 200, in an embodiment of the invention, includes the following components:
Application Proxy 120: Application proxy 120 appears to far host server 50 as an application. Application proxy 120 terminates the TCP protocol, and provides far host server 120 the required handshakes.
Proxy Queue 210: Proxy queue 210 stores the payloads for a particular TCP session. Proxy queue 210's output is a TCP payload encapsulated in a UDP packet.
UDP Queue 220: UDP Queue 220 stores the UDP sessions.
Shaper and Scheduler 230: Shaper and Scheduler 230 schedules for transmission the UDP payloads stored in both Proxy Queue 210 and UDP Queue 220 and enqueues the packets to egress Class of Service (CoS) queue 240. Furthermore, Shaper and Scheduler 230 provides both appropriate fairness for the subscribers to a cell, and appropriate fairness for all active sessions on a client.
Egress CoS Queue 240: Each cell in wireless network 10, and each cell module 200 has one or more egress CoS queues 240. For example, for UMTS, there are typically 3 cells per Node B antenna. All packets destined for the particular Node B of the cell corresponding to the cell module 200 is placed egress CoS queue 240.
Egress CoS Scheduler 250: Egress CoS scheduler 250 uses an algorithm based on typical QoS requirements to select which egress CoS queue 240 to extract the next packet to be transmitted.
Per Mobile Device Bandwidth Calculator 260: Per Mobile Device Bandwidth calculator 260, based on both the bandwidth available on wireless network 10 and the bandwidth available to mobile device 30, calculates an optimal bandwidth.

Each module described above may be implemented in hardware or software within ASM server 70.

As seen in FIG. 2, two streams of packets flow through cell module 200, a first stream handling incoming TCP packets (shown as the upper stream), and a second stream handling incoming UDP packets (shown as the lower stream).

Scheduler and Shaper 230 therefore performs two functions. The first function is scheduling the delivery of packets into egress CoS queue 240 by fairly selecting a mobile device 30 and then fairly selecting a packet from one of that particular user's session queues. In addition to scheduling, scheduler and shaper 230 shapes the flow of data, by using the incoming bandwidth information provided by per mobile device bandwidth calculator 260 about the aggregate bandwidth of all streams terminating at the particular mobile device 30, to determine mobile device 30's optimal flow speed.

Another functioned performed by ASM server 70 is to number the outgoing packets. Thus, when receiving a report from a receiver, as described below, ASM server 70 will be able to determine which packets were not received. If the last packet sent was not received, the report will not include an acknowledgement of that packet, so that ASM server 70 will be able to determine if that packet was not received.

ASM and Acknowledgement

To significantly decrease the number of Acknowledgement (ACK) packets transmitted through wireless network 10, the receiver (i.e. the mobile device 30, far host server 50, or ASM server 70 receiving the packets, as appropriate) sends a single reply containing a consolidated report of all of the current sessions with the sender. The receiver however, only transmits such a packet to the sender after the sender (i.e. the mobile device 30, far host server 50, or ASM server 70 sending the packets, as appropriate) has sent a Report-Request to the receiver. The sender dispatches Report-Requests at a pre-determined frequency t that may both minimize the time it takes for retransmission of any arbitrary lost packet, and minimize the amount of traffic on wireless network 10. To provoke the receiver to send such a report the sender sends a report-request to the receiver with a timestamp. On receipt of the report-request, the receiver replies with a report containing: the timestamp in the report-request; an ACK for the last packet received from the sender; a report of all the missing packets for all sessions from the sender; and a report containing the rate of receipt (i.e. bandwidth) since the last report-request from the sender.

If however, there is no data to retransmit, i.e. the report did not indicate packets were not received, then the sender increases t so that, in an embodiment of the invention, no more than one report-request is sent per second. If there is no more data to either send or retransmit since the last report-request and all sent data has been acknowledged, following three acknowledgements of the last packet sent, the sender may cease sending report-requests.

The report includes last packet received from the sender, so that if last packet sent is not the expected packet (e.g. packet number 9 of 10 is acknowledged three times, but not packet 10, then the sender knows packet 10 was not received).

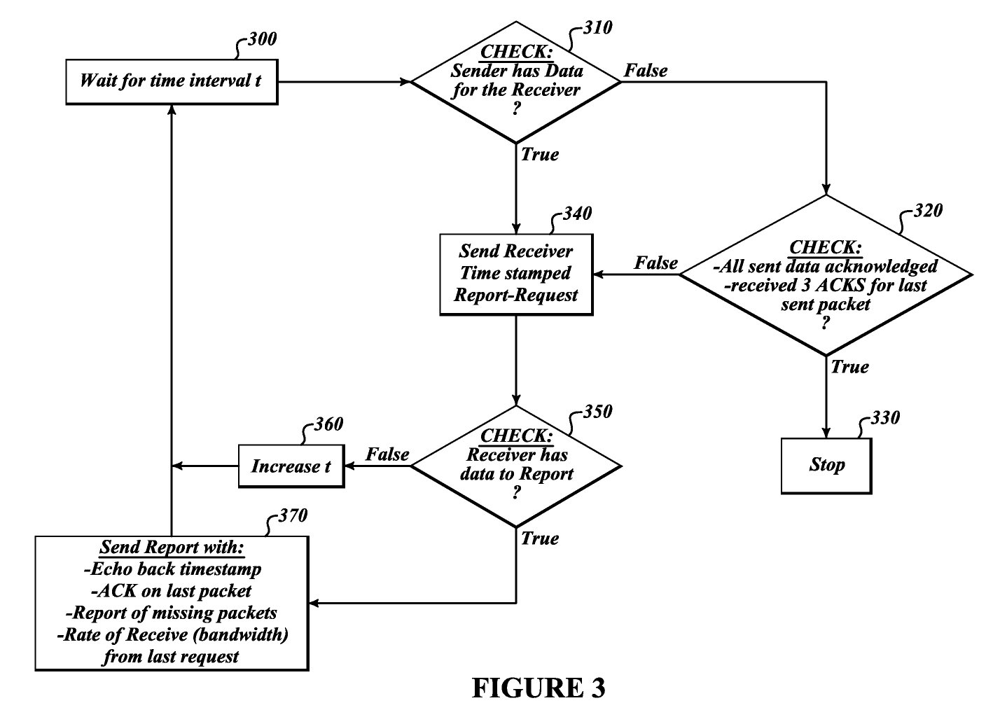

FIG. 3 displays a flow chart showing the method by which a request and report-request are transmitted. In step 300, the system waits until time t has passed. Then, the sender determines if it has new packets to send to the receiver (step 310). If there is no data for the receiver, the system then checks if all sent data has been acknowledged and three ACKs have been received for the last packet sent to receiver (step 320). If this is the case the process ends (step 330). If not, the sender sends a time stamped report-request to the receiver at step 340, which is also done if the sender has data for the receiver at step 310.

On receiving the report-request, the receiver determines if it has data to report (step 350). If not, the sender increases t (step 360) and the sender waits for the new t to pass (step 300). If there is data to report, receiver sends a report to sender, including an ACK for the last packet received, the time stamp of the report-request, a report of missing packets and the rate of receipt of packets (step 370).

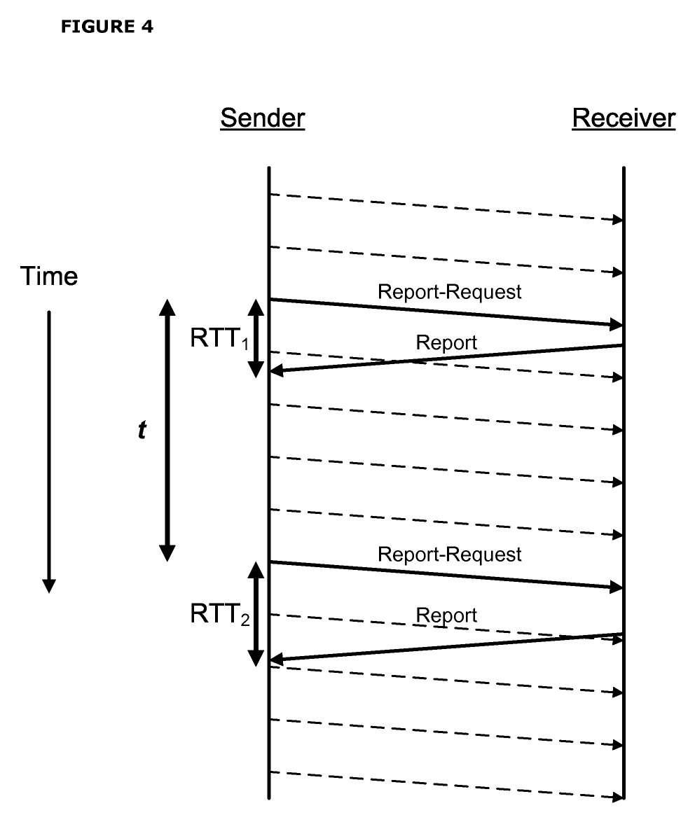

FIG. 4 provides the reader with a time diagram of the Report-Request process. RTT represents the time taken between the sending of a report-request by sender and the receipt of the report.

Use Example

An example illustrating the invention includes a mobile device 30, such as a 3G Smartphone (acting as the receiver) browsing the Internet 20 with multiple windows open, thus creating multiple sessions. The packets provided to mobile device 30 pass through a gateway, such as a Network Access Translator (NAT), that authorizes connection to the Internet 20. As the packets travel through the gateway, without loss of generality, it assumes the role of the sender and acts as ASM server 70.

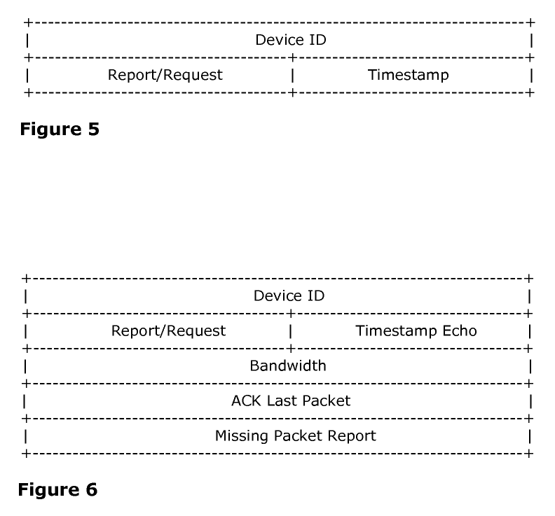

The gateway tracks the sent data packets from each of the established sessions of mobile device 30. To determine the success of each transferred packet, the gateway sends time-stamped report-request packet, as seen in FIG. 5, to mobile device 30 at a predetermined time interval t.

On receipt of the report-request, mobile phone 30 lists the packets that have not been received and sends a report, as seen in FIG. 6, to the sender. The sender enumerates all the incoming packets so the receiver easily discerns which packets were not received.

The Report/Request field within both the report-request and the report packets is a 1 bit field that indicates whether the message is request (1) or response (0).

If the sender has data to transmit but the receiver has nothing to report, the time interval t is increased via some mechanism, such as increasing t by a fixed time, or multiplying t by a fixed amount, to both maintain service levels and take advantage of available bandwidth.

Once the user of mobile device 30 has finished browsing the Internet, the sessions associated with mobile device 30 become dormant. Once the sender has received three ACKs, embedded within three reports, on the same last packet sent, all sessions are concluded and the report-request process is likewise terminated.

The transmission of report-request packets is time based so that if no report is received in the t interval, due to either a lost report-request or a lost report, the sender transmits another report-request following the expiration of t as per usual.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, or execute acts in a different order than set out in the illustrated embodiments.

The present methods, systems and articles also may be implemented as a computer program product that comprises a computer program mechanism embedded in a computer readable storage medium. For instance, the computer program product could contain program modules for installing and operating the applications described above. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and applications via the use of examples. Insofar as such examples contain one or more functions or operations, it will be understood by those skilled in the art that each function or operation within such examples can be implemented, individually and/or collectively, by a wide range of hardware, software, firmware, or virtually any combination thereof In one embodiment, the present subject matter may be implemented via Application-Specific Integrated Circuits (ASICs). However, those skilled in the art will recognize that the embodiments disclosed herein, in whole or in part, can be equivalently implemented in standard integrated circuits, as one or more computer programs running on one or more computers, as one or more programs running on one or more controllers (e.g. microcontrollers) as one or more programs running on one or more processors (e.g. microprocessors), as firmware, or as virtually any combination thereof, and that designing the circuitry or writing the code for the software and or firmware would be well within the skill of one of ordinary skill in the art in light of this disclosure.

In addition, those skilled in the art will appreciate that the applications taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g. packet links).

Further, in the methods taught herein, the various acts may be performed in a different order than that illustrated and described. Additionally, the methods can omit some acts, and/or employ additional acts.

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

I claim:

1. A method of managing a session, comprising:
receiving, at a receiver, a plurality of enumerated packets from a sender within a time period;
receiving, at said receiver, a request from said sender for a report;
if said receiver has received one or more of said plurality of packets from sender within said time period, preparing, at said receiver, a report comprising an acknowledgement of the last packet received from said sender, a list of any enumerated packets not received within said time period, and a rate of receipt of packets from said sender;
sending, from said receiver, said report to said sender.

2. The method of claim 1 wherein said on receipt of a said request, if said sender does not receive said report, said sender increases said time period, and after said increased time period sends a second request for a report to said receiver.

3. The method of claim 2 wherein after said sender has sent a predetermined number of requests for reports to said receiver, and said sender has not received said report from said receiver, said sender terminates the session.

4. The method of claim 1 wherein said sender if a mobile device, and said receiver is a gateway server to the Internet, and said gateway server transmits said packets to a far host server.

5. The method of claim 1 wherein said sender is a far host server, and said receiver is a gateway server to a wireless network, and said gateway server transmits said packets to a mobile device.

6. The system of claim 3 wherein said increased time period is determined by adding a time to said time period.

7. The system of claim 3 wherein said increased time period is determined by multiplying said time period by a multiplier.

8. A system for managing a session between a first computer and a second computer, comprising:
a server managing said session by receiving packets from said first computer, enumerating said packets and sending said packets to said second computer; and
after an interval of a fixed time period, transmitting a request for a report from said second computer;
wherein said second computer, after receiving said request, transmits a report to said server, said report containing an acknowledgement of the last packet received from said server, a list of any enumerated packets not received within said time period, and a rate of receipt of packets received from said server.

9. The system of claim 8 wherein said first computer has an application using said session, and sends said packets to said server using a TCP protocol, and said server further comprises an application proxy, said application proxy terminating said TCP protocol.

10. The system of claim 9 wherein said server further comprises a proxy queue for storing packet payloads from said packets received from said first computer, and preparing said packets for transmission using a UDP protocol to said second computer.

11. The system of claim 10 wherein said server further comprises a bandwidth calculator for determining a bandwidth for said first computer.

11. The system of claim 10 wherein said first computer is a mobile device.

12. A method of managing a session between a sending computer and a receiving computer, after said sending computer has sent a plurality of enumerated packets to said receiving computer within a fixed time period, comprising:
sending a report request to said receiving computer, said report request having a timestamp;
receiving, from said receiving computer, a report, said report comprising said timestamp, a list of said enumerated packets not received from said sending computer within said time period, and an acknowledgement of a last packet amongst said plurality of packets received.
